(19) United States
(12) Patent Application Publication
(10) Pub. No.: US 2012/0060770 A1
(43) Pub. Date: Mar. 15, 2012

(54) Choke Collar

(76) Inventor: Joel Broock, Las Vegas, NV (US)

(21) Appl. No.: 12/880,509

(22) Filed: Sep. 13, 2010

(51) Int. Cl. A01K 27/00

(52) U.S. Cl. 119/864

(57) ABSTRACT

A choke collar. The collar includes a collar strap, first proximal and distal rings affixed to proximal and distal extremities of the collar strap, a flexible cinch strap extending through the irst proximal and distal rings, and second proximal and distal rings affixed to proximal and distal extremities of the cinch strap.

### BACKGROUND

Martingale choke collars are used for training and controlling animals such as dogs. A Martingale collar according to the prior art is shown in FIG. 1. A collar strap 11 has a first proximal ring 12 connected to the strap's proximal extremity 13. A first distal ring 14 is connected to the strap's distal extremity 15. A cinch strap 16 that extends through the rings defines a loop. A collar that fits over the animal's neck is defined by the collar strap and a portion 17 of the cinch strap that lies between the rings. A leash may be connected to the cinch strap through a ring 18.

One size collar does not fit all animals. This type of choke collar must be custom made to fit one particular animal, or must be manufactured with extra material in the cinch strap to allow the collar to expand or contract to fit various animals. Even with extra material in the cinch strap, only a limited range of neck sizes can be accommodated by any one choke collar. There is a need for a Martingale choke collar that does not have to be made with excess material and that can fit a variety of animals with differing head and neck sizes.

### SUMMARY

A Martingale choke collar according to embodiments of the invention includes a collar strap, first proximal and distal rings affixed to proximal and distal extremities of the collar strap, and a flexible cinch strap extending through the first proximal and distal rings. The cinch strap is user-positionable to define straight or curved aspects. Second proximal and distal rings are affixed to proximal and distal extremities of the cinch strap. In some embodiments a coupler is detachably connectable to the second proximal and distal rings.

### BRIEF DESCRIPTION OF THE DRAWINGS

FIG. 1 is a pictorial view of a Martingale choke collar according to the prior art.

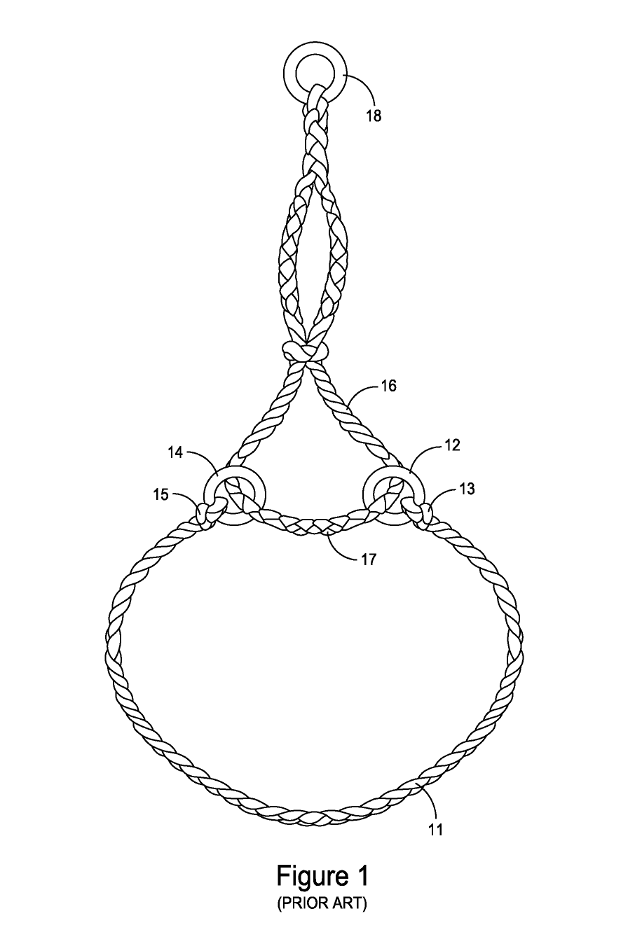

FIG. 2 is a pictorial view of a Martingale choke collar according to an embodiment of the invention.

FIG. 3 is a pictorial view of the collar of FIG. 2 with extremities of the cinch strap connected to a coupler and disposed to make the collar relatively large.

FIG. 4 is a pictorial view of the collar of FIG. 3 with extremities of the cinch strap disposed to make the collar relatively small.

FIG. 5 is a pictorial view of a coupler according to an embodiment.

FIG. 6 is a pictorial view of a coupler according to another embodiment.

FIG. 7 is a schematic illustration of a coupler according to another embodiment.

Like reference numerals are used to identify similar elements in the drawings.

### DESCRIPTION OF THE EMBODIMENTS

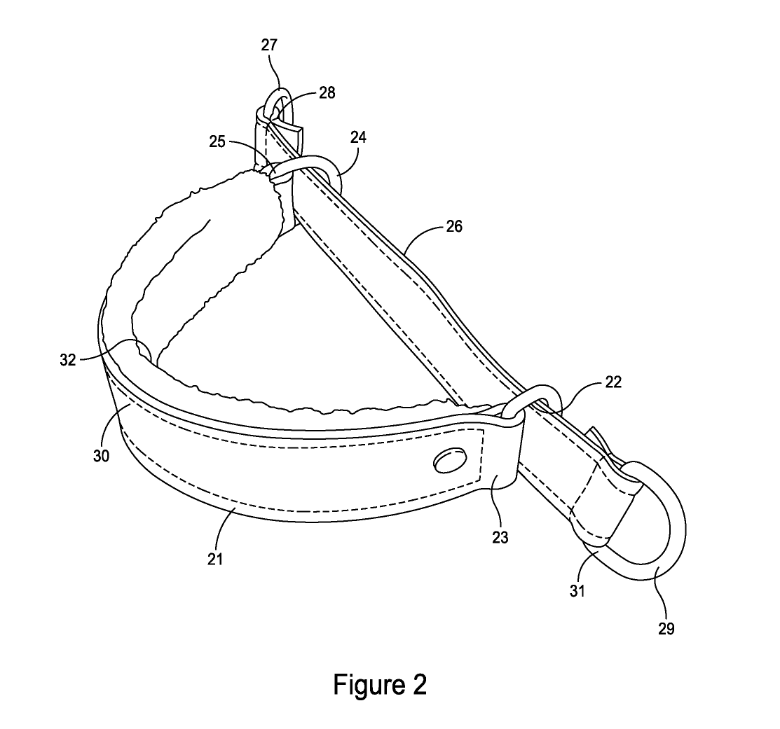

A choke collar according to an embodiment is shown in FIG. 2. The collar has a collar strap 21, a first proximal ring 22 affixed to a proximal extremity 23 of the collar strap, and a first distal ring 24 affixed to a distal extremity 25. A flexible cinch strap 26 extends through the first proximal ring and the first distal ring. The cinch strap is user-positionable to define a straight or a curved aspect. A second proximal ring 27 is affixed to a proximal extremity 28 of the cinch strap and a second distal ring 29 is affixed to a distal extremity 30.

In some embodiments the collar strap comprises relatively soft protective material 31 carried by a relatively hard supporting member 32. The soft material is for the comfort of the animal, and it protects the neck from chafing or other irritation. The supporting member may be leather or other similar material that can flex so the collar can encircle an animal's neck and that is strong enough not to tear when in use.

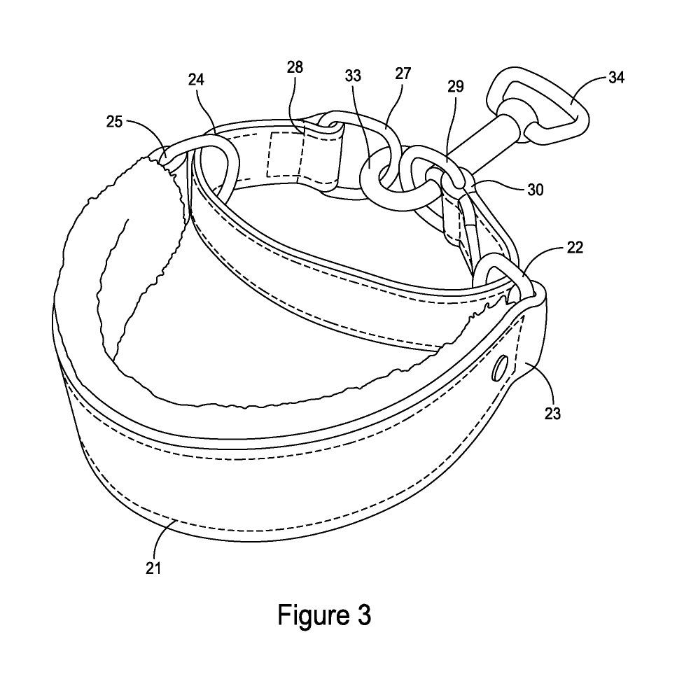

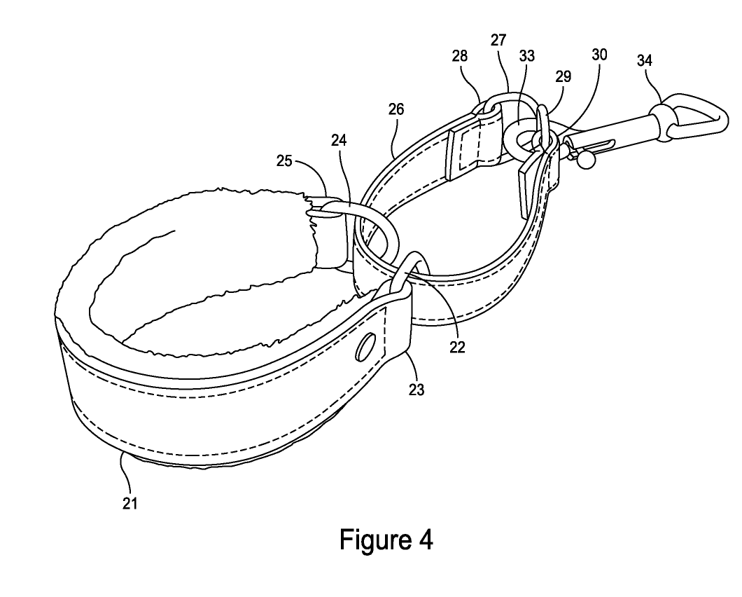

As shown in FIGS. 3 and 4, in some embodiments a coupler 33 is detachably connectable to the second proximal ring and the second distal ring. The coupler may be connected to a leash adapter 34 to which a leash may conveniently be attached. Leash adapters such as the adapter 34 are known in the art. Such an adapter typically comprises a shaft swivelingly connected either to a ring or to a spring clip, to either of which a leash may be connected.

FIG. 3 shows the cinch collar positioned for a relatively large opening to accommodate a larger animal, and FIG. 4 shows the cinch collar positioned for a relatively small opening to accommodate a smaller animal.

In some embodiments the second proximal and distal rings are sized so as not to fit through the first proximal and distal rings. In this way the cinch strap is conveniently retained in its position. In other embodiments the second proximal and distal rings may be made smaller that the first proximal and distal rings. This enables the second rings to fit through the first proximal and distal rings for easy disassembly of the choke collar.

In some embodiments D-rings are used for one or more of the first and second proximal and distal rings.

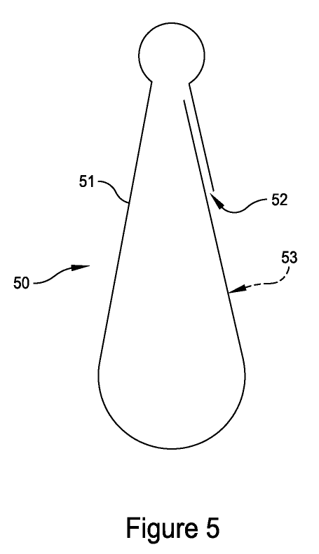

The coupler 33 may take any of several forms. One kind of coupler that can be used is a simple spring clip generally 50 as shown in FIG. 5. Spring steel 51 or the like is formed into a loop with overlapping ends that define a small opening 52. The spring action of the material keeps the opening closed until a force 53 is directed against the loop near the opening. When the force is applied, for example by squeezing with the fingers, the loop opens enough to slip the loop over the second distal and proximal rings, coupling them together. A leash may be clipped directly onto the spring clip, or the clip may carry a leash adapter such as the adapter 34 shown in FIGS. 3 and 4.

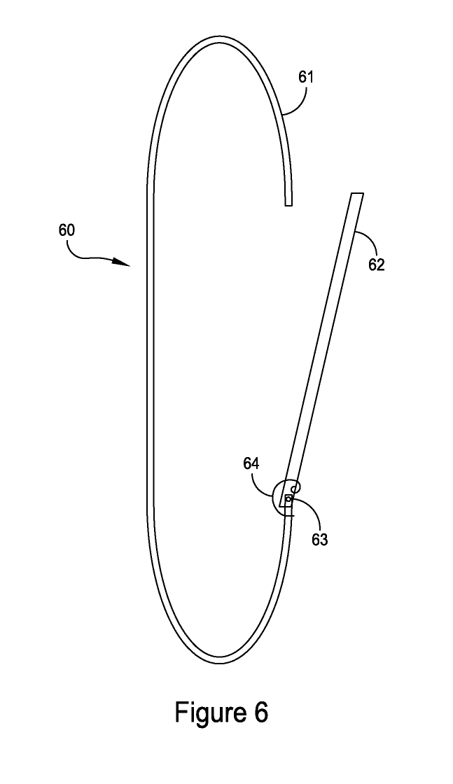

Another coupler that may be used is a spring karabiner clip generally 60 as shown in FIG. 6. A C-shaped ring 61 is made of steel, aluminum or other rigid material. A gap is defined between ends of the “C”. A member 62 is pivotingly attached to an extremity of the “C”, for example with a rivet 63 or the like. A spring 64 urges the member 62 into position across the gap to close the “C”, forming a loop. The loop may be opened by finger pressure on the member 62. As with the spring clip 50, a leash may be clipped directly onto the karabiner 60 or a leash adapter may be used.

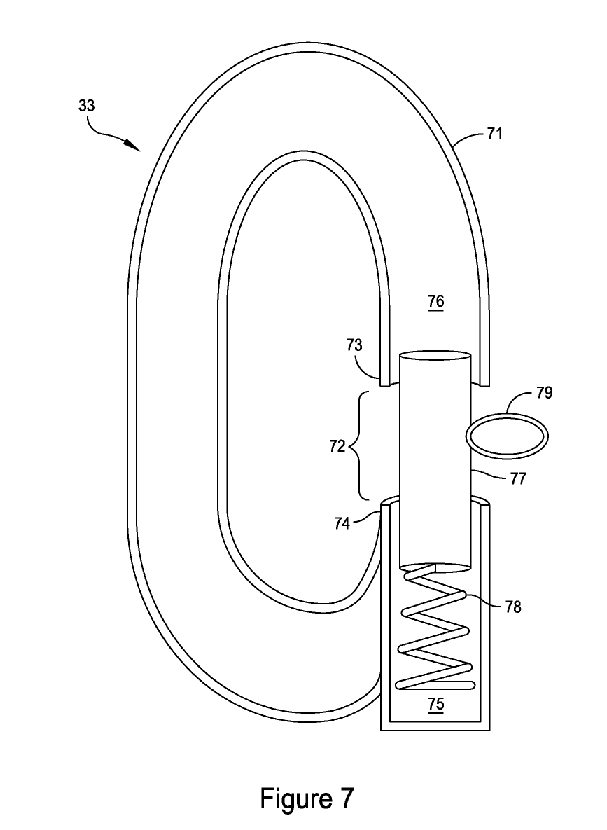

Another coupler that may be used is the coupler 31 as shown in FIGS. 3 and 4. This type of coupler is shown schematically in FIG. 7. A C-shaped member 71 defines a gap 72 between its extremities 73 and 74. An elongated cavity 75 is defined in the extremity 74, and a cavity 76 is defined in the extremity 74. A sliding member 77 is disposed in the cavity 75 and is slideably movable between a closed position as shown and an open position. A spring 78 is disposed in the cavity 75. The spring retains the sliding member in the closed position unless the sliding member is pushed into the cavity 75 in opposition to the spring, for example by means of a handle 79. A leash can be clipped onto the coupler 31 or a leash adapter may be used.

A choke collar according to the invention can accommodate several sizes of animals. A retail store can therefore meet the needs of almost any pet owner by stocking only a few sizes. Manufacture of such choke collars is relatively economical because excess material is not required in making the cinch strap.

Certain embodiments and arrangements of parts have been illustrated and described by way of example and not by way of limitation. The invention is limited only by the claims.

I claim:

1. A choke collar comprising:
a collar strap;
a first proximal ring affixed to a proximal extremity of the collar strap and a first distal ring affixed to a distal extremity of the collar strap,
a flexible cinch strap extending through the first proximal ring and the first distal ring and user-positionable to define a straight or a curved aspect; and
a second proximal ring affixed to a proximal extremity of the cinch strap and a second distal ring affixed to a distal extremity of the cinch strap.

2. A choke collar as in claim 1 and further comprising a coupler detachably connectable to the second proximal ring and the second distal ring.

3. A choke collar as in claim 2 and further comprising a leash adapter connected to the coupler.

4. A choke collar as in claim 1 wherein the coupler comprises a spring clip.

5. A choke collar as in claim 1 wherein the coupler comprises a karabiner.

6. A choke collar as in claim 1 wherein the coupler comprises:
a C-shaped member defining a gap between its extremities and a cavity in one extremity;
a sliding member disposed in the cavity and slideably movable between an open position and a closed position; and
a spring disposed in the cavity, the spring urging the sliding member into the closed position.

7. A choke collar as in claim 1 wherein the second proximal and distal rings are sized so as not to fit through the first proximal and distal rings such that the cinch strap is not removable from the collar strap.

8. A choke collar as in claim 1 wherein the first proximal and distal rings comprise D-rings.

9. A choke collar as in claim 1 wherein the collar strap comprises relatively soft protective material carried by a relatively hard supporting member.

10. A choke collar as in claim 9 wherein the relatively hard supporting member comprises leather.
